(19) United States
(12) Patent Application Publication
(10) Pub. No.: US 2025/0144649 A1
(43) Pub. Date: May 8, 2025

(54) Electrostatic Coating Machine

(71) Applicant: Carlisle Fluid Technologies, LLC, Scottsdale, AZ (US)

(72) Inventors: Tatsuya Nakaishi, Yokohama (JP); Daisuke Ota, Yokohama (JP)

(21) Appl. No.: 18/838,131

(22) PCT Filed: Feb. 14, 2023
(86) PCT No.: PCT/US2023/013025

§ 371 Date: Aug. 14, 2024

Related U.S. Application Data
(60) Provisional application No. 63/309,901, filed on Feb. 14, 2022.

(30) Foreign Application Priority Data
May 23, 2022 (JP) 2022083981

(51) Int. Cl. B05B 5/00; B05B 5/10

(52) U.S. Cl. CPC B05B 5/006; B05B 5/10

(57) ABSTRACT

A system comprising a workpiece and an electrostatic coating machine configured to electrostatically adsorb paint on the workpiece by charging the paint with a voltage output supplied from a high voltage generator, wherein a high voltage safety control unit is configured to monitor the voltage output and lower the voltage output of the high voltage generator based on a detected current being above a first overcurrent threshold, can be improved wherein a the first overcurrent threshold is a dynamic threshold based on the voltage output.

### CROSS REFERENCE TO RELATED APPLICATIONS

This application is a § 371 national stage application of international application PCT/US2023/013025, filed 14 Feb. 2023, which claims the benefit of U.S. Provisional application 63/309,901, filed 14 Feb. 2022 and Japan Patent Application 2022083981, filed 23 May 2022, from which priority is claimed and are incorporated as if fully rewritten herein.

### BACKGROUND

The present embodiments are directed to an electrostatic coating machine, and specifically, to a system comprising an electrostatic applicator and a workpiece with improved sparking prevention.

As used herein, “distal coating” refers to a distance between the workpiece and applicator set at approximately 150 mm to 300 mm. As used herein “proximity coating” refers to a distance less than 150 mm. As used herein, “ultra proximity coating” refers to a distance of less than 100 mm.

As shown in FIGS. 8-10, proximity coating is difficult and dangerous for prior art systems and ultra-proximity coating can be impossible. FIG. 8 illustrates the conventional absolute sensitivity value and current limit value settings for the distal painting method. Both absolute sensitivity value and current limit value are constant current values for high voltages. The relative relationship between absolute sensitivity value and current limit value can be current limit value (CB)<absolute sensitivity value (CL) or vice versa, absolute sensitivity value (CL)<current limit value (CB), as shown in the figure.

Current limit value (CB)<absolute sensitivity value (CL) illustrated in FIG. 8 applies to the indirect-charging electrostatic coating machine (coating machine with external electrodes). In coating machines with external electrodes, the main body of the coating machine (rotating atomizer head) and the paint supply route are grounded, and high voltage is applied to electrodes installed on the sides of the machine body. The indirect charging method is mainly used to externally charge water-based paints with low electrical resistance, and the high-voltage application part of the external electrode is mainly a needle electrode. Needle electrodes have a small volume and hold little energy, so there is little risk of ignitable discharges (hereinafter referred to as “sparks”). A “spark” is a spark discharge with discharge energy (0.24 mJ) or higher that ignites solvent vapor. In addition, water-based paints have a low risk of ignition. For this reason, indirect-charging coating machines mainly use output high-voltage control based on current limit value (CB), and overcurrent safety control based on absolute value sensitivity (CL) is used as a backup. The electrostatic coating method for water-based paints is not limited to the indirect charging method, but the direct charging method described below is also possible when using a device that electrically isolates the paint supply path.

Absolute sensitivity value (CL)<current limit value (CB) can be used in the direct-charging electrostatic coating method, in which solvent-based paints with high electrical resistance are directly charged by a rotating atomizer head. Since the rotating atomizer head includes a rotating mechanism such as a metal air motor, its electrostatic volume is large, and therefore, the energy it holds is also large. Because of this, there is a high risk of sparking, so the output of the high-voltage generator is stopped based on absolute sensitivity value before it enters the danger zone.

When current limit value (CB)<absolute sensitivity value (CL) as described above, the output current rises when the electrostatic coating machine comes abnormally close to the workpiece to be coated (hereinafter referred to as “workpiece”). The output current rises when the electrostatic coating machine approaches abnormally close to the workpiece (hereinafter referred to as “workpiece”). When the rising output current reaches the current limit value, the absolute value of the output voltage of the high voltage generator is lowered (output high voltage control function). This controls the output of the high voltage generator, i.e., the high voltage applied to the tip of the electrostatic coating machine, so that the output current does not exceed the normal current value range. In other words, the output high voltage control function prevents sparking by controlling the output of high voltage. In the output high voltage control function, the output of the high voltage generator is not shut off as described above.

Apart from the output high voltage control function described above, the output of the high voltage generator is stopped when the output current rises abnormally and reaches the absolute value sensitivity (CL), an overcurrent safety control function.

In FIG. 8, the reference code UV indicates the lower high voltage limit sensitivity. When the output voltage of the high-voltage generator drops to the lower high-voltage limit sensitivity (UV), the output of the high-voltage generator is stopped (minimum high-voltage protection control function). In other words, the output of the high voltage generator is stopped in the area below the lower high voltage limit sensitivity (UV).

The distance between the electrostatic coating machine and the workpiece, or “coating distance,” has been reduced from approximately 150 mm to 300 mm (distal coating method) to a smaller distance of 150 mm (proximity coating method). Although the proximity coating method has the advantage of improving paint transfer efficiency, the application of the proximity coating method was considered to be limited to a coating distance of up to 100 mm.

Apart from this, in recent years, there has been a trend to increase the coating speed of coating machines (“line speed”) in order to improve production efficiency. In recent years, however, there has been a trend toward increasing the coating speed of coating machines (“line speed”) to improve production efficiency. Specifically, the speed has tended to increase from the conventional 30 to 500 mm/sec to 50 to 120 mm/sec. In order to adopt the proximity coating method under such an environment, it is necessary to ensure a high level of safety and to achieve proper operation of the proximity coating method.

For example, at a linear velocity of 50 mm/sec, according to the experiment, it takes about 0.1 second from the detection of an abnormal rise in the high-voltage current caused by the electrostatic coating machine's abnormal approach to the workpiece until the coating robot comes to a complete stop. During this 0.1 second period, the electrostatic coating machine advances 50 mm. As a result, it is necessary to avoid a situation in which the robot enters the sparking zone, where sparks may occur. In addition, the frequency of penetration into the spark generation zone must be reduced in order to avoid deterioration of productivity.

The high-voltage safety control function described above is used in the distal coating method. In order to confirm whether this high-voltage safety control function can be applied to the proximal coating method, experiments were conducted and verified using a plate ground and a spherical ground. This experiment was conducted by placing a plate ground or a spherical ground close to a stationary electrostatic coating machine.

In the automobile manufacturing process, the automobile body and parts such as bumpers and door mirrors are each painted at a separate plant and brought to the assembly plant, where the finished car is made.

Plate ground means a typical example of a workpiece, such as an automobile body, in which it is easy for a discharge current to flow between the surface to be painted on the workpiece and the coating machine. On the other hand, spherical grounding, as represented by the curved surface of a door mirror cover, is a typical example of a workpiece in which the discharge current is more difficult to flow than with plate grounding, making it most difficult to ensure safety by implementing the high-voltage safety control function.

FIG. 9 shows an example experiment using plate grounding. The current limit value (CB) was set at 50 μA. The electrostatic coating machine used was a direct-charging rotary atomizing coating machine. The experiment was started with a high voltage of −60 kV applied to the electrostatic coating machine, and the plate ground was gradually brought closer to the coating machine. As can be seen in FIG. 9, when the distance between the coating machine and the workpiece was approximately 120 mm, the output high-voltage control function began to work, resulting in a gradual decrease in the output voltage of the high-voltage generator.

Keeping in mind the high line speed of 50 mm/sec mentioned above, it is desirable to stop the output of the high voltage generator before the distance between the plate ground and the electrostatic coating machine reaches 70 mm. This can be achieved by setting the lower high voltage sensitivity limit (UV) to −45 kV. When the absolute value of the output voltage of the high voltage generator drops to 45 kV by output high voltage control, the minimum high voltage protection control function is activated. That is, the output of the high-voltage generator is stopped based on the lower high-voltage limit sensitivity (set value: −45 kV). The dotted line in FIG. 9 shows the output current 402.

FIG. 10 shows an example experiment using spherical grounding. As in the plate grounding experiment (FIG. 9), the current limit value (CB) was set at 50 μA. The electrostatic coating machine used was a direct-charging rotary atomizing coating machine. The experiment was started with a high voltage of −60 kV applied to the electrostatic coating machine, and the spherical ground was gradually brought closer to the coating machine.

Spherical grounding is difficult for discharge current to flow, as described above. As a result, the output high voltage control function does not function well. As a result, the separation distance between the electrostatic coating machine and the spherical ground becomes small with insufficient output drop of the high-voltage generator, and then sparks occur as they enter the spark generation zone 401 without the forced output stop of the high-voltage generator by the minimum high-voltage protection control function being executed. As can be seen from the experimental results in FIG. 10, spherical grounding is the most severe workpiece in the high-voltage safety control function. The single-dotted line in FIG. 10 indicates the output current 402.

As the above experiment shows, in the proximity coating method, where the electrostatic coating machine is operated at a short distance to the workpiece, the risk of sparking increases as the coating distance during operation is set to a smaller value. In addition, as mentioned above, there is a demand for higher line speeds. Conducting proximity coating under these conditions further increases the risk of sparking. This means that the output of the high-voltage generator may be frequently stopped when operated under the conventional high-voltage safety control function. If the output of the high-voltage generator is stopped frequently, productivity will deteriorate. For this reason, as mentioned above, a coating distance of up to 100 mm was considered to be the limit of application for proximity coating.

In the proximity coating method, the closer the coating distance as much as possible, the higher the transfer efficiency. Therefore, there is a natural demand to operate the electrostatic coating machine as close as possible to the workpiece. Therefore, the proximity coating method requires both safety and productivity.

A purpose of the present embodiments is to provide a coating system and a high voltage safety control method that can reduce the risk of sparking in the proximity coating method.

From the standpoint of safety, it can be ideal to shut off the high voltage when there is a risk of sparking in order to avoid sparking. In proximity coating, the electrostatic coating machine is operated in proximity to the workpiece, so detection of increased discharge current, in other words, overcurrent detection, frequently occurs, and shutting off the high voltage each time is necessary can cause productivity to deteriorate.

### SUMMARY

A system comprising a workpiece and an electrostatic coating machine configured to electrostatically adsorb paint on the workpiece by charging the paint with a voltage output supplied from a high voltage generator, wherein a high voltage safety control unit is configured to monitor the voltage output and lower the voltage output of the high voltage generator based on a detected current being above a first overcurrent threshold, can be improved wherein a the first overcurrent threshold is a dynamic threshold based on the voltage output.

### BRIEF DESCRIPTION OF THE FIGURES

FIG. 1 shows an example, non-limiting view of the system disclosed herein.

FIG. 2 shows an example, non-limiting view of the electrostatic coating machine disclosed herein.

FIG. 3 shows an example, non-limiting block diagram of the logic of the high voltage safety control unit disclosed herein.

FIG. 4 shows an example, non-limiting curve regarding the setting of the current limit value (CB) and absolute sensitivity value (CL).

FIG. 5 shows an example, non-limiting curve of voltage as a function of current shown in FIG. 4.

FIG. 6 shows an example of an experiment using spherical grounding to confirm the effects of the FIG. 4 and FIG. 5.

FIG. 7 shows an example, non-limiting curve of current limit value (CB) and absolute sensitivity value (CL) as a function of current output.

FIG. 8 shows a prior art example of current limit value (CB) and absolute sensitivity value (CL) as a function of voltage.

FIG. 9 shows a graph of current and voltage as a function of coating distance for the prior art example of FIG. 8 for a plate ground.

FIG. 10 shows a graph of current and voltage as a function of coating distance for the prior art example of FIG. 8 for a spherical ground. current limit value (CB) and absolute sensitivity value (CL)

FIG. 11 shows an example, non-limiting curve of of current limit value (CB) and absolute sensitivity value (CL) as a function of detected voltage.

### DETAILED DESCRIPTION

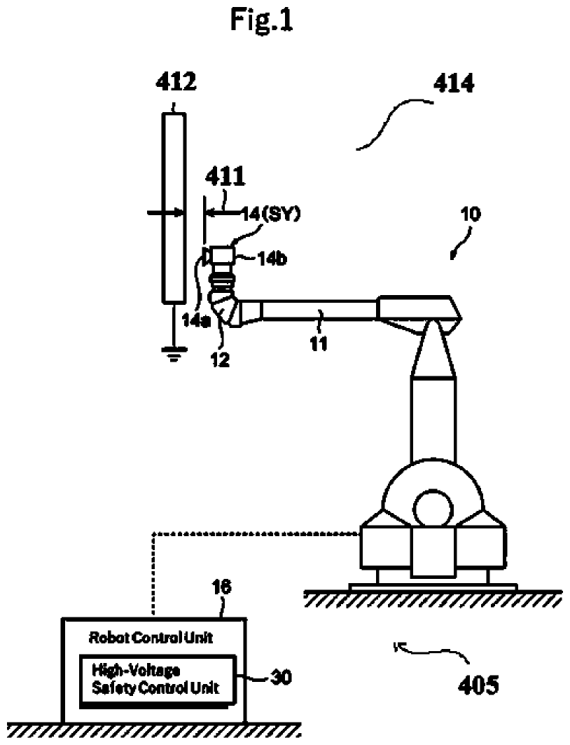

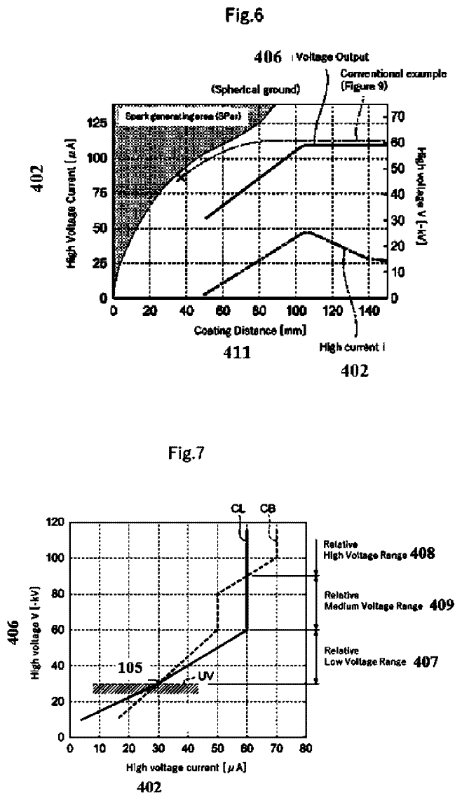

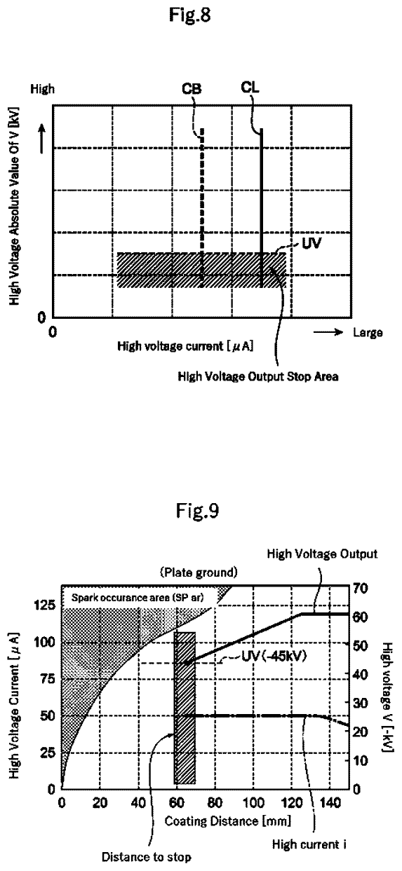

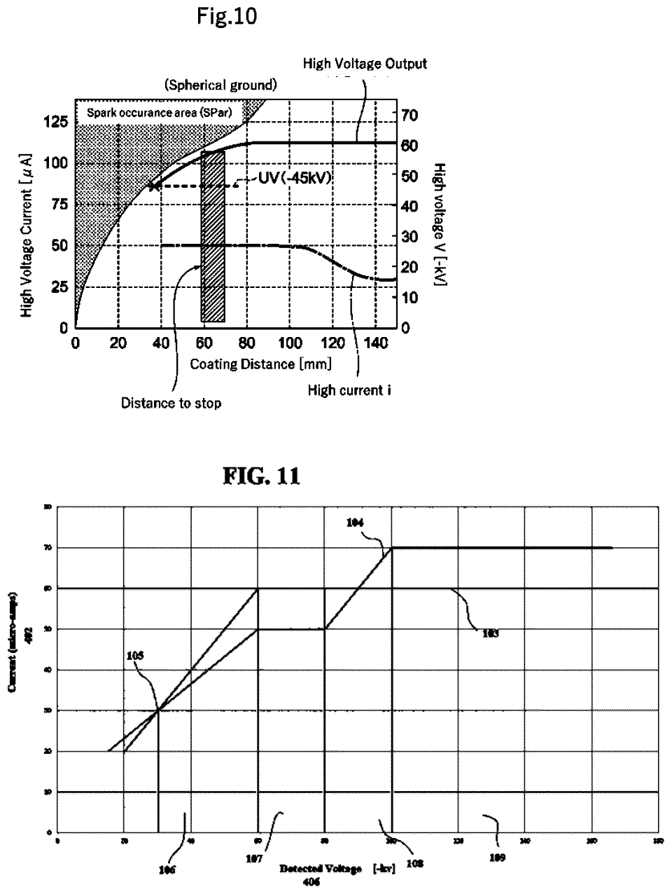

As shown in FIGS. 1-7 and 11, a painting apparatus 405 can include an electrostatic coating machine (14) which electrostatically adsorbs paint on a workpiece 412 by charging the paint with output voltage 406 supplied from a high voltage generator (24), and a high voltage safety control unit (30) which controls an output voltage 406 applied to the electrostatic coating machine (14) to ensure safety during operation. The high voltage safety control unit (30) includes an output high voltage control section (302). The output high voltage control section (302) does not stop the output of the high voltage generator (24) when an output current 402 reaches a current limit value (CB), but controls the output voltage 406 to drop an absolute value of the output voltage 406. The high voltage safety control unit (30) includes a CB setting change section (320) that changes the set value of the current limit value (CB) based on the real time value of the output voltage 406. In the CB setting change section (320), the current limit value (CB) is set to a smaller value when comparing when the absolute value of the output voltage 406 is large and when it is small in a relative low voltage range 407 where the absolute value of the high voltage of the output voltage 406 is lower than a predetermined threshold value.

A painting apparatus 405 can include an electrostatic coating machine (14) that electrostatically adsorbs paint on a workpiece 412 by charging the paint with output voltage 406 supplied from a high voltage generator (24), and a high voltage safety control unit (30) that controls high voltage applied to the electrostatic coating machine (14) to ensure safety during operation. The high-voltage safety control unit (30) includes an overcurrent safety control unit (304). The overcurrent safety control unit (304) executes control to stop the output of the high-voltage generator (24) when an abnormal increase in the output current 402 is detected based on an absolute value sensitivity (CL). The high voltage safety control unit (30) includes a CL setting change section (322) that can change a set value of the absolute value sensitivity (CL) based on a real time value of the output voltage 406. In the CL setting change section (322), the absolute value sensitivity (CL) is set to a smaller value when comparing when the absolute value of the output voltage 406 is large and when it is small in a relative low voltage range 407 where the absolute value of the high voltage of the output voltage 406 is lower than a predetermined threshold value.

The above technical problem can be solved, according to another aspect of the present embodiments, by a high voltage safety control method using an electrostatic coating machine (14) which electrostatically adsorbs paint on a workpiece 412 by charging the paint with a output voltage 406 supplied from a high voltage generator (24), and a high voltage safety control unit (30) which controls a high voltage applied to the electrostatic coating machine (14) to ensure safety during operation. The high voltage safety control unit (30) can include an output high voltage control section (302). The output high voltage control section (302) does not stop the output of the high voltage generator (24) when a output current 402 reaches a current limit value (CB), but controls the output voltage 406 to drop an absolute value of the output voltage 406. The method includes a high voltage monitoring process for monitoring the output voltage 406, and a CB setting change process for changing the set value of the current limit value (CB) based on the real time value of the output voltage 406 obtained in the high voltage monitoring process. In the CB setting change process, the current limit value (CB) is set to a smaller value when comparing when the absolute value of the output voltage 406 is large and when it is small in a relative low voltage range 407 where the absolute value of the high voltage of the output voltage 406 is lower than a predetermined threshold value.

A high voltage safety control method can include using an electrostatic coating machine (14) that electrostatically adsorbs paint on a workpiece 412 by charging the paint with output voltage 406 supplied from a high voltage generator (24), and a high voltage safety control unit (30) that controls high voltage applied to the electrostatic coating machine (14) to ensure safety during operation. The high-voltage safety control unit (30) includes an overcurrent safety control unit (304). The overcurrent safety control unit (304) executes control to stop the output of the high-voltage generator (24) when an abnormal increase in the output current 402 is detected based on the absolute value sensitivity (CL). The method can include a high voltage monitoring process for monitoring the output voltage 406, and a CL setting change process for changing the set value of the absolute value sensitivity (CL) based on the real time value of the output voltage 406 obtained in the high voltage monitoring process. In the CL setting change process, the absolute value sensitivity (CL) is set to a smaller value when comparing when the absolute value of the output voltage 406 is large and when it is small in a relative low voltage range 407 where the absolute value of the high voltage of the output voltage 406 is lower than a predetermined threshold value.

In some embodiments, the high voltage safety control unit (30) includes an overcurrent safety control unit (304) that executes control to stop the output of the high-voltage generator (24) when an abnormal increase in the output current 402 is detected based on the absolute value sensitivity (CL), and a CL setting change section (322) that changes a set value of the absolute value sensitivity (CL) based on a current, detected value of the output voltage 406. The detected value of the output voltage 406 can be an absolute value of the output voltage 406 after it has been filtered to remove pulsation. In the CL setting change section (322), the absolute value sensitivity (CL) is set to a smaller value when comparing when the absolute value of the output voltage 406 is large and when it is small in a relative low voltage range 407 where the absolute value of the output voltage 406 is lower than a predetermined threshold value. The high voltage safety control unit (30) can include an output high voltage control section (302). The output high voltage control section (302) is configured to control the output voltage 406. The output high voltage control section (302) does not stop the output of the high voltage generator (24) when a output current 402 reaches a current limit value (CB), but controls the output voltage 406 to drop an absolute value of the output voltage 406. The high voltage safety control unit (30) includes a CB setting change section (320) that changes the set value of the current limit value (CB) based on the real time value of the output voltage 406. In the CB setting change section (320), the current limit value (CB) is set to a smaller value when comparing when the absolute value of the output voltage 406 is large and when it is small in a relative low voltage range 407 where the absolute value of the high voltage of the output voltage 406 is lower than a predetermined threshold value.

The present embodiments can be applied to rotary atomizing coating machines (14) in which high voltage is applied to the rotary atomizing head (14a). In conventional proximity coating methods, a coating distance of 100 mm was considered to be the limit. According to the present embodiments, in response to changes in the output current 402, the current limit value (CB) and the absolute sensitivity value (CL), at least the set value of the absolute value sensitivity (CL) can be changed to quickly respond to the control of the electrostatic coating machine, thereby preventing the occurrence of sparks. The present embodiments can enable ultra-close coating with the coating distance set at, for example, approximately 100 mm to 20 mm.

As shown in FIG. 1, an electrostatic coating machine 14 can be assembled to the wrist 12 at the end of the robot arm 11. The electrostatic coating machine 14 can have a rotating atomizing head 14a, which can be positioned at the tip of the coating machine body 14b. The electrostatic coating machine 14 can be a rotating atomizing type coating machine. The coating robot 10, including the electrostatic coating machine 14, can be controlled by the control unit 16.

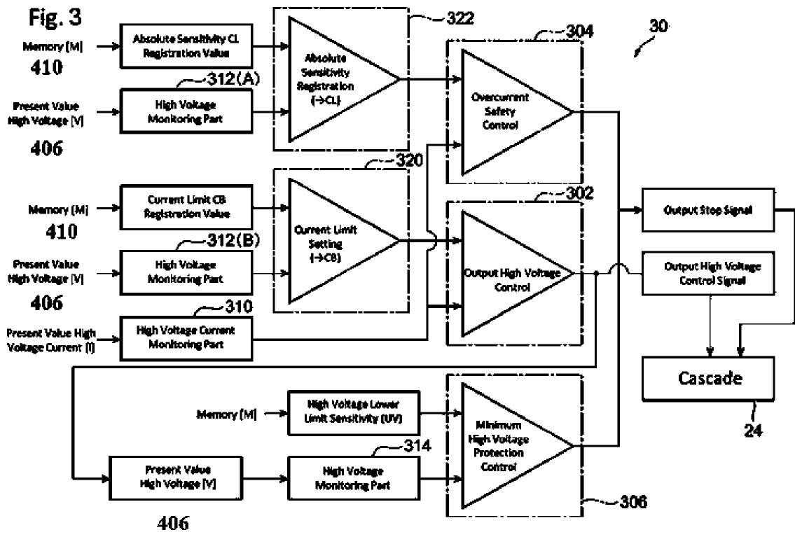

The high voltage control of the electrostatic coating machine 14 can be controlled by a different unit than the control unit 16. The control unit 16 controlling the coating robot 10 can include a high voltage safety control unit 30. The high voltage safety control unit 30, together with the electrostatic coating machine 14, comprises the coating system SY. The high voltage safety control unit 30 may be incorporated in the control unit 16 or in a separate unit. The high voltage safety control section 30 has an output high voltage control section 302, an overcurrent safety control section 304, and a minimum high voltage protection control section 306 (FIG. 3).

The high voltage safety control section 30 has a high voltage real time value monitoring section 310 that constantly monitors the current output current 402 and a high voltage monitoring section 312 (A), (B) that constantly monitors the current high voltage V. The high-voltage current value monitoring section 310 takes in the output current 402 that is not affected by the pulsation component AV due to the Cockcroft-Walton circuit.

The current value of the output current 402 is supplied from the high voltage real time value monitoring section 310 to the output high voltage control section 302 and the overcurrent safety control section 304. The output high voltage control section 302 generates an output high voltage control signal that reduces the value of the output voltage 406 of the Cascade 24 when the rising output current 402 reaches the current limit value (CB), as in the past. The output of Cascade 24 is controlled based on this output high voltage control signal (output high voltage control function (CB)).

As in the past, the overcurrent safety control section 304 generates an output stop signal when the output current 402 rises abnormally to a value higher than the absolute value sensitivity (CL). Based on this output stop signal, the output of the 24 Cascades is stopped (overcurrent safety control function (CL)).

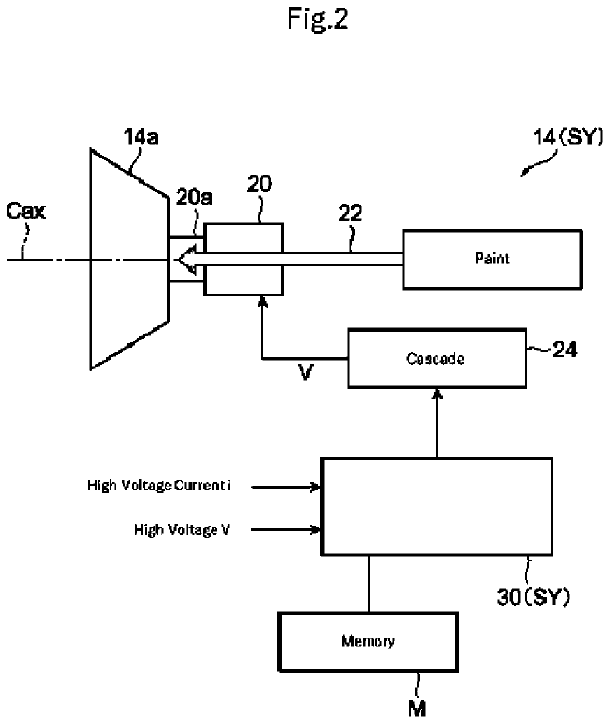

As shown in FIG. 2, the electrostatic coating machine 14 can have an air motor 20, and the rotating atomizing head 14a is connected to the motor output shaft 20a of the air motor 20. The rotary atomizing head 14a is driven by the air motor 20. The motor output shaft 20a is hollow. A paint supply tube 22 is positioned at the center axis 413 of the air motor 20 in the hollow motor output shaft 20a, and paint is supplied to the center of the rotating atomizing head 14a through the paint supply tube 22. In other words, the electrostatic coating machine 14 is a center-feed coating machine.

The electrostatic coating machine 14 can have a high voltage generator (hereinafter referred to as “Cascade”) 24 is built into the machine. Cascade 24 generates output voltage 406 by means of the well-known Cockcroft-Walton circuit. The output voltage 406 generated by the Cascade 24 is supplied to the rotating atomization head 14a via the air motor 20. In other words, the air motor 20 described above is made of metal, and the metal air motor 20 constitutes part of the high voltage application pathway that applies high voltage to the rotary atomization head 14a. Paint supplied to the rotating atomization head 14a can be directly charged by the rotating atomization head 14a while being atomized. In other words, the electrostatic coating machine 14 is a direct-charging coating machine. Instead of the Cascade 24 built into the electrostatic coating machine 14, a high voltage generated by a high voltage generator (not shown) separate from the electrostatic coating machine 14 may be supplied to the rotating atomizing head 14a.

In FIG. 3, reference code 320 indicates the CB setting change section and reference code 322 indicates the CL setting change section. The current limit value (CB) setting can be changed in the CB setting change section 320 to become the current limit value (CB) corresponding to the current value based on the current value of output voltage 406. Here, the data related to the current limit value (CB) shown in FIG. 4 can be pre-registered in the memory 410. In the CL setting change section 322, the registered value of absolute sensitivity value (CL) corresponding to the high voltage value read from the memory 410 (FIG. 2) can be input, and the set value of absolute sensitivity value (CL) can be changed in the CL setting change section 322 to become the absolute sensitivity value (CL) corresponding to the current value based on the real time value of the output voltage 406. Here, the data related to the absolute value sensitivity (CL) shown in FIG. 4 can be pre-registered in the memory 410.

The current value of output voltage 406 supplied from the high voltage monitoring sections 312(A) and 312(B) to the CB setting change section 320 and CL setting change section 322 can be the value after passing through a strong filter that mitigates the effects of the pulsation component ΔV described above. Current limit value (CB) can be performed in the output high voltage control section 302 based on the current limit value (CB) setting received from the CB setting change section 320. The overcurrent safety control section 304 executes overcurrent safety control (CL) based on the set value of absolute sensitivity value (CL) received from the CL setting change section 322.

The value of output voltage 406 generated by the output high voltage control section 302 can be supplied to the minimum high voltage protection control section 306 through the high voltage value monitoring section 314 as it can be the real time output voltage 406 value. The minimum high voltage protection control section 306 receives the registered value of the lower high voltage limit sensitivity UV read from the memory 410 (FIG. 2), and the minimum high voltage protection control section 306 performs minimum high voltage protection control based on the registered value of the lower high voltage limit sensitivity UV. In other words, the output of the high voltage generator of Cascade 24 can be stopped when the absolute value of the output voltage of Cascade 24 falls below the registered value of the lower high voltage limit sensitivity UV. First example regarding setting value change (CB setting value change)

FIG. 4 illustrates a first example regarding the setting of the current limit value (CB). FIG. 4 also illustrates a second example regarding the setting of the current limit value (CB) and absolute sensitivity value (CL).

Referring to FIG. 4, the high voltage change region (voltage drop due to current limit value (CB)) in proximity coating operation is, in this example, the absolute value of output voltage 406 can be 60 kV or lower. The region above this output voltage 406 change region can be called the “relative high voltage region 408”. The relative high voltage region 408 corresponds to a coating distance 411 of 200 mm or more. On the other hand, the region where the absolute value of output voltage 406 can be lower than the relative high voltage region 408 can be called the “relative low voltage region 407”. The relative low voltage region 407 corresponds to a coating distance 411 of 20 mm to 200 mm.

In the relative high voltage range 408, the current limit value (CB) can be a constant value with respect to the output voltage 406 (CB can be about 50 μA). On the other hand, in the relative low voltage range 407, the set value of the current limit value (CB) can be changed.

Specifically, in the relative low voltage range 407, when the absolute value of the output voltage 406 can be large compared to that of the output voltage 406, the set value of the current limit value (CB) can be changed to a smaller value when the absolute value of the output voltage 406 can be small. In the relative low voltage range 407, the set value of the current limit value (CB) can be changed to a smaller value as the absolute value of the output voltage 402 becomes lower (from about 30 μA to about 50 μA or less). In some embodiments, in the relative low-voltage region 407, the current limit value (CB) can be gradually changed to a smaller value as the absolute value of output voltage 406 decreases, as can be seen in FIG. 4. This setting change of the current limit value (CB) can be performed by the CB setting change section 320 (FIG. 3). Each value of output voltage 406 and the corresponding current limit value (CB) setting can be registered in memory 410 (FIG. 2).

In operation, the CB setting change section 320 reads the registered value of the current limit value (CB) corresponding to the real time value of the output voltage 406 from the memory 410 and provides the set value of the current limit value (CB) based on this read registered value of the current limit value (CB) to the output high voltage control section 302 (FIG. 3). The output high voltage control performed in the output high voltage control section 302 can be based on the set value of the current limit value (CB) received from the CB setting change section 320.

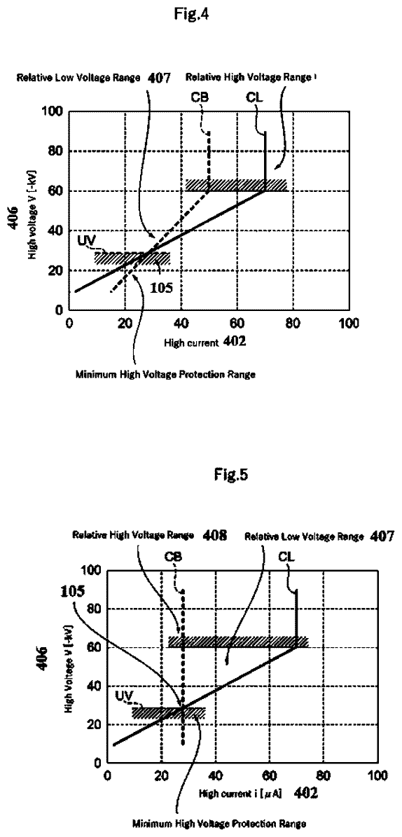

FIG. 5 shows a variant of this second example (FIG. 4). This variant has in common with the second example (FIG. 4) in that the set value of absolute sensitivity value (CL) can be changed, but the set value of current limit value (CB) can be constant even if the value of output voltage 406 changes. When the set value of current limit value (CB) can be set to a relatively small value (e.g. 30 μA), the set value of current limit value (CB) may remain constant even when the value of output voltage changes.

Referring to FIG. 4 and FIG. 5, in the relative low-voltage range 407, when the absolute value of the output voltage 406 can be large and when it can be small, the set value of the absolute value sensitivity (CL) can be set to a smaller value when the absolute value of the output voltage 406 can be small. In the relative low voltage range 407, the set value of the absolute value sensitivity (CL) can be changed to a smaller value as the absolute value of the output voltage 406 becomes lower. In some embodiments, as can be seen in FIG. 4 and FIG. 5, in the relative low voltage range 407, the set value of the absolute value sensitivity (CL) can be gradually changed to a smaller value as the absolute value of the output voltage 406 becomes lower. Then, when contrasted at the same output voltage, the absolute value sensitivity (CL) can be set to a value greater than the current limit value (CB) (CB<CL). The lower the absolute value of the high voltage V, the larger the difference between the absolute value sensitivity (CL) and the current limit value (CB) should be set.

According to the second example (FIG. 4) and the variant (FIG. 5), when a spark occurs due to a breakdown or accident, for example, that is, when the current limit value (CB) cannot follow up in time, the overcurrent safety control can be executed based on the absolute value sensitivity (CL) which can be set to a small value as the absolute value of the output voltage 406 drops. control can be executed and the output of Cascade 24 can be shut down. This overcurrent safety control can back up safety assurance.

In the second example (FIG. 4) and the variant example (FIG. 5), as in the first example, each value of output voltage 406 and the corresponding set value of current limit value (CB) and each value of output voltage 406 and the corresponding set value of absolute value sensitivity (CL) should be registered in advance in memory 410 (FIG. 2).

### Third Example Regarding Setting Value Change (Intersection of CB Setting Change Characteristic Line and CL Setting Change Characteristic Line)

As can be seen from FIG. 4 and FIG. 5, it can be recommended to intersect the CB setting change characteristic line of the current limit value (CB) and the CL setting change characteristic line of the absolute value sensitivity (CL). The set voltage value of Cp at the intersection point where the absolute sensitivity value (CL) and the current limit value (CB) become the same value (about 30 μA) can be the registered value of the lower limit sensitivity (UV) (about −30 kV). The registered value of the lower high voltage sensitivity (UV) can be the threshold value of the minimum high voltage protection control, as described above, and the output of Cascade 24 can be stopped when the absolute value of the output voltage 406 of Cascade 24 falls below the registered value of the lower high voltage sensitivity (UV) below the intersection point 105. This area where the output can be stopped can be called the “minimum high voltage protection area M V ar.

In FIG. 4 and FIG. 5, in the relative low-voltage range 407, the current limit value (CB) can be lower than the absolute sensitivity value (CL) when compared at the same output voltage. On the other hand, in the minimum high voltage protection region M V ar, which can be the region below the registered value of the lower high voltage limit sensitivity (UV), the relationship between the current limit value (CB) and absolute sensitivity value (CL) can be reversed, and absolute sensitivity value (CL)<current limit value (CB), unlike in the relative low voltage region 407.

The advantage of current limit value<absolute sensitivity value (CB<CL) when contrasted with the same output voltage in the relative low voltage range 407 can be explained below. If the workpiece 412 has edges, such as the body of a vehicle, the discharge current flows easily at the edges and the output current 402 temporarily rises. Even if the coating line can be not stopped due to the activation of absolute sensitivity value (CL) at the edge, the electric field concentrates at the edge, causing the coating film of paint adhering to the edge to become too thick. In addition, when the electric field can be concentrated at the edge, the paint does not spread to the area deeper than the edge, resulting in a problem of insufficient coating film on the surface to be coated other than the edge.

For workpieces 412 with many edges, the robot control program uses a coating method that reduces the absolute value of output voltage or strengthens the shaping air, and the coating can be executed under a coating program that can be adapted to workpieces 412 with many edges.

As mentioned above, recent years have seen a demand for faster line speeds in coating. However, coating programs can only be operated in units of the part to be coated (e.g. 1 sec). Therefore, if the output voltage remains at a low absolute value for the remaining 0.9 sec (an area of 450 mm at a line speed of 500 mm/sec) due to an edge with a passing time of only 0.1 sec, for example, or if the coating can be performed with shaping air that remains strong, the transfer efficiency will be reduced.

In the relatively low voltage range 407, if CB<CL when compared with the same output voltage, the output voltage can be suppressed only at the necessary moment with a current limit value (CB) appropriate for the edge condition (appropriate field strength), thus maintaining the high transfer efficiency that can be achieved with proximity coating.

In the relative low voltage range 407, CB<CL when contrasted at the same output voltage, as described above, the difference between the current limit value (CB) and absolute sensitivity value (CL) should gradually decrease as the absolute value of output voltage 406 decreases.

In the relative low-voltage region 407, the larger the absolute value of output voltage 406 can be relatively (in FIG. 4 and FIG. 5, the region far from the intersection point 105), the larger the fluctuation of the value of output current 402 with respect to the change in absolute value of output voltage 406. If the fluctuation of the output current 402 can be large, the output high voltage control based on the current limit value (CB) cannot keep up, and the output current 402 becomes larger than the current limit value (CB), and the possibility that it reaches the absolute value sensitivity (CL) can be large. When the absolute sensitivity value (CL) can be detected, the overcurrent safety control function can be activated and the output of the 24 Cascade can be stopped. The less frequently this output can be stopped, the better. For this purpose, when the absolute value of output voltage 406 can be relatively large in the relatively low voltage range 407, it can be recommended to set the values of current limit value (CB) and absolute sensitivity value (CL) so that the difference value between current limit value (CB) and absolute sensitivity value (CL) gradually increases so that CB can be substantially less than CL when compared at the same output voltage. It can be recommended to set the values of current limit value (CB) and absolute sensitivity value (CL) so that the difference between CB and absolute sensitivity value (CL) gradually increases.

In the relative low voltage region 407, when the absolute value of output voltage 406 can be relatively small (the region close to the intersection point 105), the amount of variation in the value of output current 402 with respect to changes in the absolute value of output voltage 406 can be small. In this region, it can be recommended to set the values of current limit value (CB) and absolute sensitivity value (CL) so that the difference value between current limit value (CB) and absolute sensitivity value (CL) can be small. By gradually reducing the difference between the current limit value (CB) and the absolute value sensitivity (CL), the backup function by the overcurrent safety control function (CL) can be activated quickly to ensure safety.

On the other hand, in the minimum high-voltage protection range M V ar below the registered value of the lower high-voltage limit sensitivity (UV), whose absolute value can be about 30 kV, i.e., below the intersection Cp, the relationship between the current limit value (CB) and the absolute sensitivity value (CL) can be reversed, and when contrasted at the same output voltage, absolute sensitivity value (CL)<current limit value (CB) when contrasted at the same output voltage. As can be seen from FIG. 4 and FIG. 5, in the minimum high voltage protection range M V ar, the lower the absolute value of high voltage, the larger the difference between absolute sensitivity value (CL) and current limit value (CB).

The Cockcroft-Walton circuit can contain a large amount of pulsation component ΔV in the output voltage 406. For this reason, a strong filter can be required to detect the output voltage 406. Therefore, the sudden drop in the absolute value of output voltage 406 due to current limit value (CB) can be mitigated by the filter, and the timing for detecting output changes can be delayed. In contrast, since the output current 402 can be the current value before it can be input to the Cockcroft-Walton circuit, there can be no pulsation component ΔV. Therefore, there can be no need to equalize the output current 402 with a filter, and fluctuations in the output current 402 can be detected immediately.

The delay in detecting a change in output voltage 406 can be due to the delay in detecting that the current output voltage 406 has fallen below the registered value of the lower high voltage limit sensitivity (UV), and if the output voltage (V) has entered the minimum high voltage protection range M Var, this entry can be effectively caused by the output current 402, which has no delay can be detected.

In the minimum high voltage protection range M V ar, the absolute sensitivity value (CL)<current limit value (CB) when contrasted at the same output voltage, the overcurrent safety control can be first executed to stop the output of Cascade 24 by the absolute sensitivity value (CL). The current limit value (CB) serves as a backup to the overcurrent safety control (CL).

Even though the current output voltage (V) can be detected by monitoring the output voltage 406, as mentioned above, detection of this output voltage 406 can be slow. Quick control based on the pre-registered absolute sensitivity value (CL) and current limit value (CB) can achieve both productivity and safety.

### Variation of the Setting Change Characteristic Line (FIG. 7)

FIG. 7 shows a variation of the current limit value (CB) and absolute sensitivity value (CL) setting change characteristic lines. Referring to FIG. 7, the area above the minimum high voltage protection range M V ar, i.e., the area where the absolute value of output voltage 406 can be higher than the registered value of the lower high voltage limit sensitivity (UV), can be divided into three areas.

The range of the high voltage lower limit sensitivity (UV) between the registered value (−30 kV) and −60 kV can be called the “relative low voltage range 407”. The relative low voltage range 407 corresponds to a coating distance 411 of 50 mm to 200 mm. In the relative low-voltage range 407, the change range of the current limit value (CB) setting value can be 30 μA to 50 μA, and the change range of the absolute sensitivity value (CL) setting value can be 30 μA to 60 μA. The relative relationship between the current limit value (CB) and absolute sensitivity value (CL) can be CB<CL when contrasted at the same output voltage.

The −60 kV to −90 kV range can be called the “relative medium voltage range 409”. The relative medium voltage range 409 corresponds to a coating distance 411 of 200 to 300 mm. This relative medium voltage range 409 can be the applicable range of the distal painting method.

When the painting distance 411 can be 200 mm, the initial high voltage can be set to −60 kV. When the coating distance 411 can be 300 mm, the initial high voltage can be set to −90 kV.

The region where the absolute value of the output voltage can be 90 or higher can be called the “relative high voltage region 408”. The relative high voltage region 408 corresponds to a coating distance 411 of 300 mm or more.

In the relative high voltage range 408, the absolute sensitivity value (CL) can be set to less than the current limit value (CB). In other words, the CB setting change characteristic line and the CL setting change characteristic line should intersect at the boundary between the relative high voltage range 408 and the relative medium voltage range 409, and in the relative high voltage range 408, the absolute sensitivity value (CL) should be set to<current limit value (CB). In this relative high voltage region 408, the absolute value of output voltage 406 can be extremely high and the risk of sparking can be high. Therefore, the overcurrent safety control based on the absolute value sensitivity (CL) can be operated in advance. This can be a good way to prevent the occurrence of sparks.

The characteristic lines illustrated in FIG. 7 have the following advantages. That is, the characteristic lines illustrated in FIG. 7 can be suitably applied when the application of the coating robot 10 including the electrostatic coating machine 14 can be not limited to the proximity coating method, but can be operated including the distal coating method, i.e. the coating system can be applied not only to the proximity coating method but also to the distal coating method.

FIG. 11 shows an example of the the current limit value (CB) and absolute sensitivity value (CL) that can be retrieved from memory 410. In a system 413 comprising a workpiece 412 and an electrostatic coating machine 10 configured to electrostatically adsorb paint on the workpiece 412 by charging the paint with a voltage output 406 supplied from a high voltage generator 24, wherein a high voltage safety control unit is configured to monitor the voltage output and lower the voltage output of the high voltage generator based on a detected current 402 being above a first overcurrent threshold, the first overcurrent threshold 104, which can be the currently limit value (CB) can be a first dynamic threshold 104 based on the voltage output 406. The voltage output 406 can be the absolute value of a detected voltage that is filtered to remove pulsation. In some embodiments, the high voltage safety control unit 30 is configured to stop the output of the high voltage generator 24 based on the detected current 402 being above a second overcurrent threshold 103, which can be the absolute sensitivity value (CL), wherein the second overcurrent threshold is a second dynamic threshold 103 based on the voltage output 406. In some embodiments, the high voltage safety control unit 30 can include at least one output voltage monitor to receive a detected voltage corresponding to the absolute value of the voltage output, wherein the first dynamic threshold 104 comprises at least one first overcurrent range and at least one second overcurrent range, wherein the first overcurrent range is lower than the second overcurrent range. According to certain embodiments, the second dynamic threshold 103 increases as the detected voltage increases within a first voltage domain 106. The first dynamic threshold 104 can be increasing in this range, but can increase linearly or nonlinearly.

According to some embodiments, the second dynamic threshold 103 is defined by second dynamic threshold 103 (μA)=k1*the detected voltage+k2, wherein k1 and k2 are constants, wherein k1 is positive, when the detected voltage is within a first voltage domain 106. In some embodiments, the first voltage domain 106 can be between UV and 60 kV, k1 can be between 0.5 and 2, and in some embodiments 1, and k2 can be between −10 and 10, and in some embodiments 0. In some embodiments, the second dynamic threshold 103 is defined by second dynamic threshold 103 (μA)=k3, wherein k3 is a constant, when the detected voltage is within a second voltage domain 151, wherein the second voltage domain 151 is at a higher absolute value than the first voltage domain 106. In some embodiments, the second voltage domain 151 can be when the detected voltage is greater than 60 kV. In some embodiments, k3 can be between 50 and 70, and in some embodiments 60. According to certain embodiments, the first dynamic threshold 104 increases as the detected voltage increases within the first voltage domain 106. In some embodiments, the first dynamic threshold 104 is defined by first dynamic threshold 104 (μA)=k4*the detected voltage+k5, wherein k4 and k5 are constants, wherein k4 is positive, when the detected voltage is within the first voltage domain 106. In some embodiments, k4 can be between ½ and ¾, and in some embodiments ⅔, and k5 can be between 0 and 20, and in some embodiments 10. According to some embodiments, the first dynamic threshold 104 is defined by first dynamic threshold 104 (μA)=k6, wherein k6 is a positive constant, when the detected voltage is within a first portion 107 of the second voltage domain 151. In some embodiments, the first portion 107 of the second voltage domain 151 can be between 60 and 80 kV, and k6 can be between 40 and 60, and in some embodiments 50. In some embodiments, the first dynamic threshold 104 increases as the detected voltage increases within the second portion 108 of the second voltage domain 151. According to some embodiments, the first dynamic threshold 104 can be defined by first dynamic threshold 104 (μA)=k7*the detected voltage+k8, wherein k7 and k8 are constants, wherein k7 is positive, when the detected voltage is within a second portion 108 of the second voltage domain 151, wherein the second portion 108 of the second voltage domain 151 is higher than the first portion 107 of the second voltage domain 151. In some embodiments, k7 can be between 0.5 and 3, and in some embodiments 1, and k8 can be between −50 and −10, and in some embodiments −30. In some embodiments, the first dynamic threshold 104 is defined by first dynamic threshold 104 (μA)=k9, wherein k9 is a positive constant, when the detected voltage is within a third portion 109 of the second voltage domain 151, wherein the third portion 109 of the second voltage domain 151 is higher than the second portion 108 of the third voltage domain. In some embodiments, k9 can be between 60 and 80, and in some embodiments 70. In some embodiments, the second dynamic threshold 103 is the same as the first dynamic threshold 104 at a voltage output 406 equal to a lower bound of the of first voltage domain 106, wherein the lower bound of the first voltage domain 106 is a minimum voltage threshold 104 (UV) of the high voltage safety control unit. In some embodiments, the second dynamic threshold 103 is lower than the first dynamic threshold 104 at a voltage output 406 above the lower bound of the first voltage domain 106 and below an upper bound, wherein the upper bound is in the second portion 108 of the second voltage domain 151, wherein the second dynamic threshold 103 is higher than the first dynamic threshold 104 above the upper bound. In some embodiments, the electrostatic coating machine comprises an applicator, wherein the system comprises a distance 411 between the workpiece 412 and the applicator, wherein the distance 411 between the workpiece 412 and applicator is between 50 mm and 200 mm when the detected voltage is in the first voltage domain 106, wherein the distance 411 between the workpiece 412 and applicator is between 200 mm and 300 mm when the detected voltage is in the second voltage domain 151 below the upper bound, and wherein the distance 411 between the workpiece 412 and applicator is greater than 300 mm at a detected voltage above the upper bound.

The description of the present embodiments has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

Therefore, it is intended that the disclosure not be limited to the particular embodiments disclosed for carrying out this disclosure, but that the disclosure will include all embodiments falling within the scope of the appended claims.

We claim:

1. In a system comprising a workpiece and an electrostatic coating machine configured to electrostatically adsorb paint on the workpiece by charging the paint with a voltage output supplied from a high voltage generator, wherein a high voltage safety control unit is configured to monitor the voltage output and lower the voltage output of the high voltage generator based on a detected current being above a first overcurrent threshold, the improvement comprising:
the first overcurrent threshold is a first dynamic threshold based on the voltage output.

2. The improvement of claim 1, wherein the high voltage safety control unit is configured to stop the output of the high voltage generator based on the detected current being above a second overcurrent threshold, wherein the second overcurrent threshold is a second dynamic threshold based on the voltage output.

3. The improvement of claim 2, wherein the high voltage safety control unit comprises at least one output voltage monitor to receive a detected voltage corresponding to the absolute value of the voltage output, wherein the first dynamic threshold comprises at least one first overcurrent range and at least one second overcurrent range, wherein the first overcurrent range is lower than the second overcurrent range.

4. The improvement of claim 3, wherein the second dynamic threshold increases as the detected voltage increases within a first voltage domain.

5. The improvement of claim 4, wherein the second dynamic threshold is defined by second dynamic threshold (μA)=k1*the detected voltage+k2;
wherein k1 and k2 are constants, wherein k1 is positive, when the detected voltage is within a first voltage domain.

6. The improvement of claim 5, wherein the second dynamic threshold is defined by second dynamic threshold (μA)=k3,
wherein k3 is a constant, when the detected voltage is within a second voltage domain, wherein the second voltage domain is at a higher absolute value than the first voltage domain.

7. The improvement of claim 6, wherein the second dynamic threshold increases as the detected voltage increases within the first voltage domain.

8. The improvement of claim 7, wherein the first dynamic threshold is defined by
first dynamic threshold (μA)=k4*the detected voltage+k5,
wherein k4 and k5 are constants, wherein k4 is positive, when the detected voltage is within the first voltage domain.

9. The improvement of claim 8, wherein the first dynamic threshold is defined by first dynamic threshold (μA)=k6,
wherein k6 is a positive constant, when the detected voltage is within a first portion of the second voltage domain.

10. The improvement of claim 9, wherein the first dynamic threshold increases as the detected voltage increases within the second portion of the second voltage domain.

11. The improvement of claim 10, wherein the first dynamic threshold is defined by first dynamic threshold (μA)=k7*the detected voltage+k8,
wherein k7 and k8 are constants, wherein k7 is positive, when the detected voltage is within a second portion of the second voltage domain, wherein the second portion of the second voltage domain is higher than the first portion of the second voltage domain.

12. The improvement of claim 11, wherein the first dynamic threshold is defined by first dynamic threshold (μA)=k9,
wherein k9 is a positive constant, when the detected voltage is within a third portion of the second voltage domain, wherein the third portion of the second voltage domain is higher than the second portion of the third voltage domain.

13. The improvement of claim 12, wherein the second dynamic threshold is the same as the first dynamic threshold at a voltage output equal to a lower bound of the of first voltage domain, wherein the lower bound of the first voltage domain is a minimum voltage threshold of the high voltage safety control unit.

14. The improvement of claim 13, wherein the second dynamic threshold is lower than the first dynamic threshold at a voltage output above the lower bound of the first voltage domain and below an upper bound, wherein the upper bound is in the second portion of the second voltage domain, wherein the second dynamic threshold is higher than the first dynamic threshold above the upper bound.

15. The improvement of claim 14, the electrostatic coating machine comprises an applicator, wherein the system comprises a distance between the workpiece and the applicator, wherein the distance between the workpiece and applicator is between 50 mm and 200 mm when the detected voltage is in the first voltage domain, wherein the distance between the workpiece and applicator is between 200 mm and 300 mm when the detected voltage is in the second voltage domain below the upper bound, and wherein the distance between the workpiece and applicator is greater than 300 mm at a detected voltage above the upper bound.
